(19) United States
(12) Patent Application Publication
(10) Pub. No.: US 2015/0127183 A1
(43) Pub. Date: May 7, 2015

(54) MASTER INTELLIGENT ELECTRONIC DEVICE FOR HIGH LEVEL APPLICATIONS

(71) Applicant: ABB Technology AG, Zurich (CH)

(72) Inventor: Horst Büker, Minden (DE)

(73) Assignee: ABB Technology AG, Zurich (CH)

(21) Appl. No.: 14/598,692

(22) Filed: Jan. 16, 2015

Related U.S. Application Data
(63) Continuation of application No. PCT/EP2013/001767, filed on Jun. 14, 2013.

(30) Foreign Application Priority Data
Jul. 16, 2012 (EP) 12005219.6

(51) Int. Cl. G06F 1/26; H04L 12/24

(52) U.S. Cl. CPC G06F 1/26; H04L 41/08; H04L 2012/4026
USPC 700/295

(57) ABSTRACT

A master-IED (Intelligent Electronic Device) is disclosed for high level applications (e.g., in power management or load shedding applications in power generation facilities or in electric power transformation), which can include at least one communication interface supporting MMS client and GOOSE functionality (CI-1, CI-2 . . . CI-n), wherein each is configured as an IED with its own configurable CID-file according to an IEC 61850 requirement. The master-IED specific IEC 61850 configuration tool can handle SCD (Substation Configuration Description)—files per a communication interface CI-1.

### RELATED APPLICATIONS

This application claims priority as a continuation application under 35 U.S.C. §120 to PCT/EP2013/001767, which was filed as an International Application on Jun. 14, 2013 designating the U.S., and which claims priority to European Application 12005219.6 filed in Europe on Jul. 16, 2012. The entire contents of these applications are hereby incorporated by reference in their entireties.

### FIELD

The present disclosure relates to a master-IED (Intelligent Electronic Device) used in high level applications such as power management or load shedding applications, whereby the master-IED can include MMS-(Manufacturing Message Specification) client and GOOSE (Generic Object Oriented Substation Events) publisher-subscriber functionality. Furthermore the present disclosure relates to a sub-network system (e.g., in power generation facilities or in electric power transformation substations).

### BACKGROUND INFORMATION

In the IEC 61850 specification, as an Ethernet-based international standard for communication in power generation facilities and electric power transformation substations to integrate all of the protection, control, measurement and monitoring functions, IEDs are specified with MMS server, GOOSE provider and subscriber functionality. In the IEC 61850 specification, a GOOSE protocol is scheduled for data exchange among IEDs, also called horizontal communication or horizontal fast IED-IED communication, and can be based on peer-to-peer communication.

The mechanism GOOSE (Generic Object Oriented Substation Events) describes a control model mechanism in which any format of data (e.g., status, value), are grouped into a data set, transmitted within a short time period and used to ensure specified transmission speed and reliability.

GOOSE data is directly embedded into Ethernet data packets and works on publisher-subscriber mechanism on multicast or broadcast addresses. The GOOSE communication is specified in the IEC 61850 Standard by the International Electrotechnical Commission (IEC).

The IEC61850 GOOSE is an advanced version of the UCA GOOSE. A GOOSE message is used to exchange data between IED's. GOOSE is a mechanism for fast transmission of substation events, such as commands and alarms. A single GOOSE message sent by an IED can be received and used by several receivers. In a common sub-network one device (the sender) publishes information, while only the subscriber devices are receiving it. The reaction of each receiver depends on its configuration and functionality.

Furthermore GOOSE is designed as Publisher-Subscriber model and the publisher IED transmits as multicast to all connected subscriber IEDs. For example, all IEDs that communicate via GOOSE messages have to be combined in one sub-network. The sub-network could be a physical sub-network or via a VLAN (Virtual LAN) configuration in a logical sub-network, so that important signals (e.g., protection signals) can only be transferred between IEDs in the same sub-network.

The Manufacturing Message Specification (MMS) is described in the international standard ISO 9506 and deals with a messaging system for transferring real time process data and supervisory control information between networked devices in a distributed network or automation system.

A MMS protocol is foreseen for a vertical point-to-point communication from the IED's to a SCADA (Supervisory Control and Data Acquisition) OPC server for data access, operation, alarm/event and archive functionality. In the IEC 61850 specification this OPC server interface is specified as Logical Note IHMI (Human Machine Interface or also called SCADA systems) and is used as a group indicator for interfacing and archiving functions.

The OPC server is connected to each IED as a client and has access to all configured IED's record control blocks where values with quality and time stamp are configured.

### SUMMARY

A master-IED (Intelligent Electronic Device) is disclosed for specified power management, load management and/or electric power transformation applications, the master IED comprising: a MMS client and GOOSE publisher-subscriber functionality module for specified applications; and at least one communication interface (CI-1, CI-2 . . . CI-n), wherein each communication interface is configured as an IED with its own configurable CID-file according to an IEC 61850 requirement and combines a functional combination from an IEC 61850 specified remote control interface (ITCI).

A sub-network system in power generation facilities or in electric power transformation substations, is also disclosed, comprising: at least one master-IED with a communication interface (CI-1); and an additional OPC interface, the master-IED being connected via the communication interface (CI-1) to a sub-network (SN_1) and via the additional OPC interface to a SCADA system.

### BRIEF DESCRIPTION OF THE DRAWINGS

Features and advantages disclosed herein, as well as advantageous refinements and improvements, will be described and explained in more detail using the exemplary embodiments illustrated in the following drawings, in which:

FIG. 1 shows an exemplary a master-IED with a communication interface to a sub-network and an additional OPC interface to a SCADA system in a distributed network;

FIG. 2 shows an exemplary master-IED of a redundant embodiment for communication interfaces integrated in the master-IED and an additional OPC interface to a SCADA system in a distributed network; and

FIG. 3 shows an exemplary sub-network system used in a power generation facilities or in an electric power transformation substation with a master-IED with a redundant core board and communication interfaces, wherein each master-IED core board has its, own OPC server interface in redundant manner to a SCADA system in a distributed network.

### DETAILED DESCRIPTION

Known substation IEDs have only one Ethernet interface, specified according IEC 61850 Edition1, and for the new defined redundancy requirement in IEC 61850 Edition2 a second Ethernet interface with switch functionality inside the IED as enhanced high-availability seamless redundancy (HSR) or as an IEC62439-6 standard compliant redundant ring (DRP) protocol.

IEC 61850 now specifies a network redundancy that fulfills the requirements of substation automation, for the station bus as well as for the process bus. It is based on two complementary protocols defined in the IEC 62439-3 standard: parallel redundancy protocol (PRP) and high-availability seamless redundancy (HSR) protocol. Both are able to overcome the failure of a link or switch with zero switchover time, while allowing clock synchronization according to IEEE 1588 to operate reliably. Developed by ABB in collaboration with other companies, both PRP and HSR will be part of the second edition of the IEC 61850 standard.

For high level applications, analog values like voltage and current are needed as inputs for this task. The actual GOOSE communication between the IEDs is not clearly specified and not all IED vendors can support analog values via the GOOSE communication. A general concept for high level applications, such as power management or load shedding (load management) can not be realized in such IEDs.

Accordingly, exemplary embodiments disclosed herein are directed to a new master-IED having publisher-subscriber functionality for high level applications (e.g., power management or load shedding applications in power generation facilities or in electric power transformation substations).

An exemplary Master-IED as disclosed herein can include at least one communication interface (CI) designed (i.e., configured) as an IED itself which functionally combines an IEC 61850 specified remote control interface (ITCI). In the IEC 61850 specification this Logical Node ITCI represents a remote control or telecontrol interface for connection to higher control functionality. ITCI refers to a group indicator for interfacing and archiving functions (I) and telecontrol and/or remote control interface (TCI).

Exemplary embodiments disclosed herein also can receive information as an MMS client via record control block configured analog and/or binary values from each IED that is connected with the master-IED. The Master-IED communication interface IED can, in addition, support the GOOSE provider and subscriber functionality to send calculation results as a multicast signal to all connected IEDs for enhanced, rapid reaction time.

Furthermore, exemplary embodiments relate to a sub-network system (e.g., in power generation facilities or in electric power transformation), wherein at least one master-IED with a communication interface and an additional OPC interface is provided and the master-IED is connected via the communication interface to a sub-network and via the OPC interface to a SCADA system.

In an exemplary embodiment of a system as disclosed herein, a master-IED specific IEC 61850 configuration tool is provided to handle SCD (Substation Configuration Description)—files per a communication interface CI-1.

Exemplary embodiments as disclosed herein can allow for operation of all kinds of high level applications, such as power management and loading shedding. Application results and actions can be transmitted as point-to-point commands to each IED separately, or via GOOSE communication as a multicast to all connected IEDs in the sub-network.

In an exemplary embodiment, a base functionality module (e.g., software and/or hardware functionality) for signal mapping, and an additional number of modular communication interfaces each designed (i.e., configured) as an IED with its own configurable CID-file according to an IEC 61850 requirement are also provided.

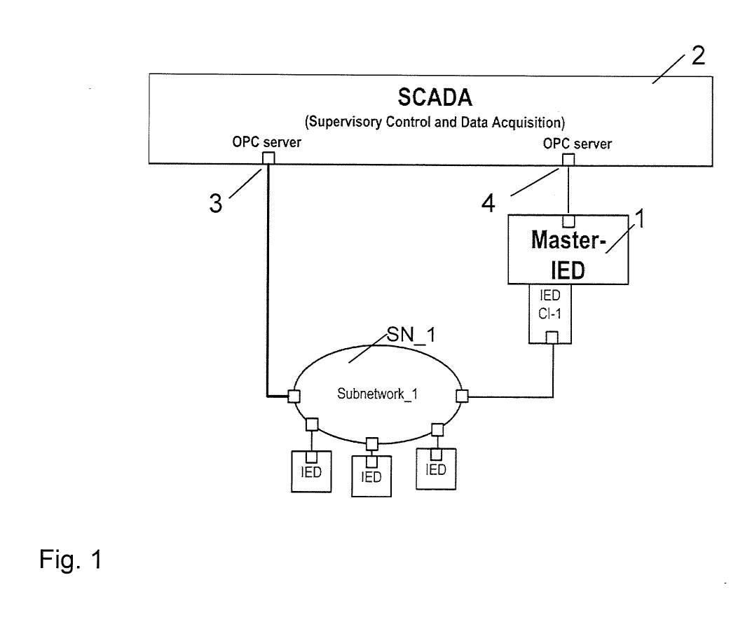

FIG. 1 presents an exemplary portion of a distributed network including a master-IED 1 with a communication interface IED CI-1 and an additional OPC interface 4. The master-IED 1 is connected via the communication interface CI-1 to a sub-network SN_1 and via the OPC interface 4 to a SCADA system 2.

The master-IED 1 can include, via the communication interface IED CI-1, a MMS—(Manufacturing Message Specification) client and a GOOSE (Generic Object Oriented Substation Events) publisher-subscriber functionality (e.g., software and/or hardware module). By providing such new functionality in the master-IED 1, it is possible to change an IEC61850 IED specific configuration tool to handle SCD (Substation Configuration Description)- files per communication interface CI-1. A SCD-file is a file describing a complete configured substation in details.

The sub-network SN_{—}1 can contain a plurality of IED's and is connected with the OPC-Server 3 of the SCADA system 2. The IEC 61850 compatible communication interface CI-1 of the master-IED 1 is provided to work as a MMS-client and is able to receive information via record control block configured analog and/or binary values from each IED as a point-to-point connection. IEDs are intelligent electronic devices as automation components for substation automation, such as controllers in a distributed control system (DCS).

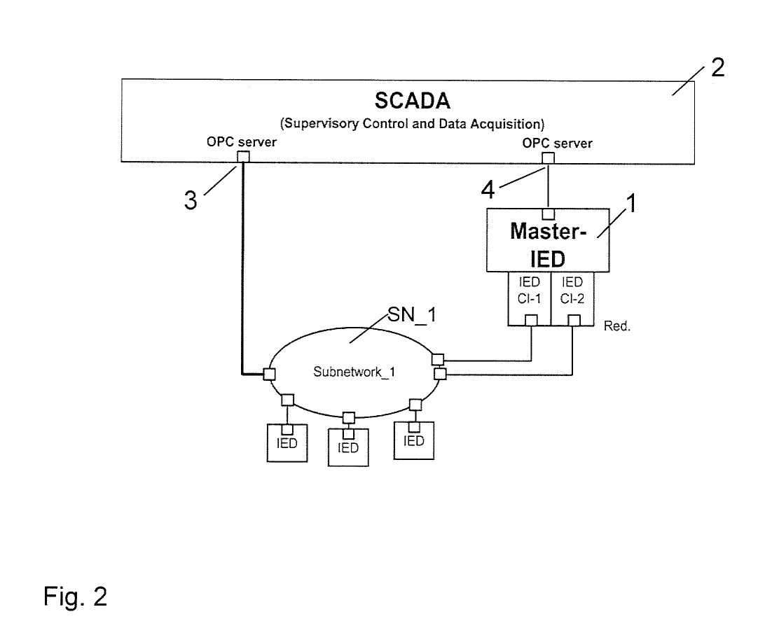

FIG. 2 is shown an exemplary master-IED 1 with two communication interfaces CI-1, CI-2 integrated in the master-IED 1. The second communication interface CI-2 is a redundant component to the first communications interface CI-1. Each communication interface CI-1, CI-2 is connected to a sub-network SN_1.

For enhanced higher availability, the master-IED 1 is used in a redundant manner such as redundant communication interfaces CI-1, CI-2, in which the two communication interfaces IED (CI-1 and CI-2) are configured in the same sub-network as an MMS client and GOOSE publisher and/or subscriber.

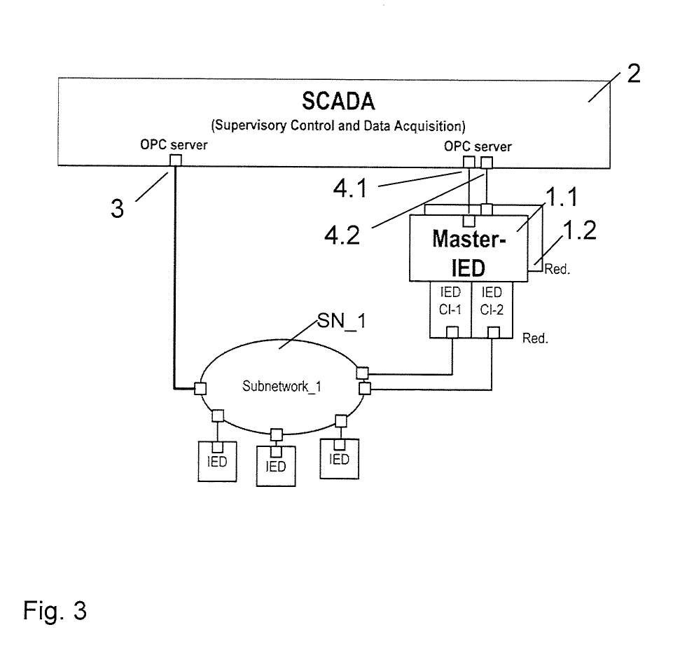

FIG. 3 presents a further exemplary portion of a distributed network also referenced to as a sub-network system used in power generation facilities or in an electric power transformation substation with a master-IED 1.1, 1.2 with a redundant core board and communication interfaces CI-1, CI-2 additionally working in redundant configuration and including redundant OPC interfaces 4.1, 4.2 to the SCADA system 2 for a higher, enhanced availability.

The exemplary master-IED 1, 1.1, 1.2 as disclosed herein can include communications interfaces CI-1, CI-2 with an MMS—(Manufacturing Message Specification) client and a GOOSE (Generic Object Oriented Substation Events) functionality.

As a result a master-IED 1, 1.1, 1.2 as disclosed herein can provide a routing functionality inside the IED. Additionally Ethernet network switches can provide such functionality.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A master-IED (Intelligent Electronic Device) for specified power management, load management and/or electric power transformation applications, the master IED comprising:
a MMS client and a GOOSE publisher-subscriber functionality module for specified applications; and
at least one communication interface (CI-1, CI-2 . . . CI-n), wherein each communication interface is configured as an IED with its own configurable CID-file according to an IEC 61850 requirement and combines a functional combination from an IEC 61850 specified remote control interface (ITCI).

2. The master-IED according to claim 1, configured to receive information as an MMS client via record control block configured analog and/or binary values from each IED that is connected with the master-IED.

3. The master-IED according to claim 1, comprising:
a base functionality module for signal mapping; and
an additional number of module communication interfaces (CI-1, CI-2 . . . CI-n) each configured as an IED with its own configurable CID-file according to an IEC 61850 requirement.

4. The master-IED according to claim 1, comprising:
a remote control interface to receive information as an manufacturing Message Specification (MMS) client via record control block configured analog and/or binary values from each IED that is connected with the master-IED.

5. The master-IED according to claim 1, comprising:
an additional GOOSE provider and subscriber functionality for sending calculation results of the master-IED as a multicast signal to all connected IEDs.

6. The master-IED according to claim 1, comprising:
a communication interface functionality for transmitting application results and actions as point-to-point commands to each connected IED separately, or via a GOOSE communication as a multicast to all connected IED's in a sub-network.

7. The master-IED according to claim 1, comprising:
a base functionality module for signal mapping; and
plural communication interfaces, each configured as an IED with its own configurable CID-file according to an IEC 61850 requirement.

8. The master-IED according to claim 1, comprising:
at least two communication interfaces (CI-1, CI-2) integrated in the master-IED, each communication interface (CI-1, CI-2) being connected to a sub-network (SN_1) and the two communication interfaces (CI-1, CI-2) being configured in the sub-network (SN_1) as publisher and/or subscriber.

9. The master-IED according to claim 1, configured a redundant core board and comprising:
communication interfaces (CI-1, CI-2) for enhanced availability.

10. A sub-network system in power generation facilities or in electric power transformation substations, comprising:
at least one master-IED with a communication interface (CI-1); and
an additional OPC interface, the master-IED being connected via the communication interface (CI-1) to a sub-network (SN_1) and via the additional OPC interface to a SCADA system.

11. The sub-network system according claim 10, comprising:
a master-IED specific IEC 61850 configuration tool to handle SCD (Substation Configuration Description)—files per the communication interface (CI-1).

12. The master-IED according to claim 2, comprising:
a base functionality module for signal mapping; and
an additional number of module communication interfaces (CI-1, CI-2 . . . CI-n) each configured as an IED with its own configurable CID-file according to an IEC 61850 requirement.

13. The master-IED according to claim 12, comprising:
a remote control interface to receive information as an MMS client via record control block configured analog and/or binary values from each IED that is connected with the master-IED.

14. The master-IED according to claim 13, comprising:
an additional GOOSE provider and subscriber functionality for sending calculation results of the master-IED as a multicast signal to all connected IEDs.

15. The master-IED according to claim 14, comprising:
a communication interface functionality for transmitting application results and actions as point-to-point commands to each connected IED separately, or via a GOOSE communication as a multicast to all connected IED's in a sub-network.

16. The master-IED according to claim 15, comprising:
a base functionality module for signal mapping; and
plural communication interfaces, each configured as an IED with its own configurable CID-file according to an IEC 61850 requirement.

17. The master-IED according to claim 16, comprising:
at least two communication interfaces (CI-1, CI-2) integrated in the master-IED, each communication interface (CI-1, CI-2) being connected to a sub-network (SN_1) and the two communication interfaces (CI-1, CI-2) being configured in the sub-network (SN_1) as publisher and/or subscriber.

18. The master-IED according to claim 17, configured a redundant core board and comprising:
communication interfaces (CI-1, CI-2) for enhanced availability.
